(19) United States
(12) Patent Application Publication
(10) Pub. No.: US 2022/0025232 A1
(43) Pub. Date: Jan. 27, 2022

(54) TWO-COMPONENT ADHESIVE

(71) Applicant: EMULSION TECHNOLOGY CO., LTD., Mie (JP)

(72) Inventors: Masaki MORITSUGU, Mie (JP); Reina OKADA, Mie (JP); Takahiro MIYATA, Mie (JP)

(73) Assignee: EMULSION TECHNOLOGY CO., LTD., Mie (JP)

(21) Appl. No.: 17/297,323

(22) PCT Filed: Nov. 21, 2019
(86) PCT No.: PCT/JP2019/045658

§ 371 Date: May 26, 2021

(30) Foreign Application Priority Data
Nov. 27, 2018 (JP) 2018-221724

(51) Int. Cl. C09J 175/08; C08G 18/10; C08G 18/48; C08G 18/76; C08G 18/79; C08G 18/20; C08G 18/70

(52) U.S. Cl. CPC C09J 175/08; C08G 18/10; C08G 18/4812; C08G 18/7657; C08K 2003/265; C08G 18/791; C08G 18/7614; C08G 18/2027; C08G 18/702; C08G 18/797

(57) ABSTRACT

Provided by the present invention is a two-component adhesive which includes a first composition and a second composition, in which the first composition contains: a complex derived from an organoborane and a first compound having a first group capable of undergoing an addition reaction to an isocyanate group; and a second compound having a plurality of hydroxy groups, and the second composition contains: a third compound having a plurality of isocyanate groups; a fourth compound having a polymerizable group; and a dehydrating agent. Provided that a mass of the fourth compound in the second composition is X, and that a total mass of the second compound in the first composition and the third compound in the second composition is Y, a value X/(X+Y) is preferably no less than 0.4 and no greater than 0.85.

### TECHNICAL FIELD

The present invention relates to a two-component adhesive.

### BACKGROUND ART

In order to address environmental problems in recent years, reduction in weight of automobiles and the like has been demanded, and thus resinous materials are extensively used. The resinous material requires an adhesive used for joining resinous materials with one another, or for joining with a material of a different type such as metal. However, among the resinous materials, polypropylenes, which are superior in terms of recyclability and costs, are materials for which adhesion by means of adhesives is difficult.

As a material that enables adhesion of such a poorly adhesive material, in recent years, an adhesive in which an organoborane complex is used has been investigated (see, Japanese Unexamined Patent Application (Translation of PCT Application), Publication No. H11-512123 and PCT International Publication No. 2012/160452). In this adhesive: one composition contains a complex derived from the organoborane and a compound having a group capable of undergoing an addition reaction to an isocyanate group; and another composition contains a compound having an isocyanate group and a polymerizable group. According to the adhesive, through mixing two compositions upon the adhesion, the compound having a group capable of undergoing an addition reaction to an isocyanate group reacts with the compound having an isocyanate group and a polymerizable group. Thus, the organoborane having a polymerization-initiating ability is released, thereby enabling an adhesive component to be hardened and adhered. In this case, since a radical generated from the released organoborane and oxygen molecules can modify the surface of a poorly adhesive material such as polypropylene, superior adhesiveness is reportedly attained even when a plasma treatment or the like is not carried out.

### PRIOR ART DOCUMENTS

### Patent Documents

Patent Document 1: Japanese Unexamined Patent Application (Translation of PCT Application), Publication No. H11-512123

Patent Document 2: PCT International Publication No. 2012/160452

### SUMMARY OF THE INVENTION

### Problems to be Solved by the Invention

It is desired that such an adhesive can form an adhesion layer superior in flexibility in a case in which adhesion to a flexible base material is to be achieved, and particularly in a case in which different types of materials are to be adhered, with the materials having different thermal expansion coefficients, for example. However, in an attempt to enhance flexibility of the adhesion layer, adhesion strength usually tends to be decreased, which may result from decreased strength of the adhesion layer. Moreover, such a conventional adhesive described above has a drawback of still being insufficient in storage stability.

The present invention was made in view of the foregoing circumstances, and an object of the present invention is to provide a two-component adhesive which is capable of forming an adhesion layer superior in flexibility while maintaining the adhesion strength, and is superior in storage stability.

### Means for Solving the Problems

According to an aspect of the invention made for solving the aforementioned problems, a two-component adhesive comprises a first composition (hereinafter, may be also referred to as “composition (I)”) and a second composition (hereinafter, may be also referred to as “composition (II)”), wherein the composition (I) comprises: a complex (hereinafter, may be also referred to as “(A) complex” or “complex (A)”) derived from the organoborane and a first compound (hereinafter, may be also referred to as “compound (a)”) having a first group (hereinafter, may be also referred to as “group (X)”) capable of undergoing an addition reaction to an isocyanate group; and a second compound having a plurality of hydroxy groups (hereinafter, may be also referred to as “(B) compound” or “compound (B)”), and the composition (II) comprises: a third compound (hereinafter, may be also referred to as “(C) compound” or “compound (C)”) having a plurality of isocyanate groups: a fourth compound (hereinafter, may be also referred to as “(D) compound” or “compound (D)”) having a polymerizable group; and a dehydrating agent (hereinafter, may be also referred to as “(E) dehydrating agent” or “dehydrating agent (E)”).

### Effects of the Invention

The two-component adhesive of the aspect of the present invention is capable of forming an adhesion layer superior in flexibility while maintaining the adhesion strength, and is superior in storage stability. Therefore, the two-component adhesive can be suitably used for adhesion of a variety of materials including poorly adhesive materials such as outer panels for automobiles.

### DESCRIPTION OF EMBODIMENTS

### Two-Component Adhesive

The two-component adhesive includes the composition (I) and the composition (II). Mixing of the composition (I) and the composition (II) of the two-component adhesive allows a reaction (a deprotection reaction) of the compound (C) having a plurality of isocyanate groups in the composition (II) with the compound (a) having the group (X) capable of undergoing an addition reaction to the isocyanate group constituting the complex (A) in the composition (I), and as a result, an organoborane, and a reaction product (hereinafter, may be also referred to as “deprotection reaction product (p)”) of the compound (a) and the compound (C) are produced. The compound (D) having a polymerizable group in the composition (II) is polymerized using, as a polymerization initiator, the organoborane generated, and further forms a bond, etc., with an adherend via a radical formed from the organoborane, for example, whereby adhesion proceeds.

The two-component adhesive includes the composition (I) containing the complex (A) and the compound (B); and the composition (II) containing the compound (C), the compound (D), and the dehydrating agent (E). As such, the two-component adhesive can form an adhesion layer superior in flexibility while maintaining the adhesion strength, and is superior in storage stability. Although not necessarily clarified, the reason for achieving the effects described above due to the two-component adhesive involving the constitution described above may be presumed, for example, as in the following. In conventional two-component adhesives, it is believed that the isocyanate group included in the compound (C) is likely to react with the moisture coming from the air and the like, and disappears with time. Consequently, it is considered that the storage stability is impaired because of time-dependent lowering of the production speed of the organoborane through a reaction of the isocyanate group of the compound (C) with the compound (a) having the group (X) capable of undergoing an addition reaction to the isocyanate group constituting the complex (A). According to the present invention, disappearance of the isocyanate group of the compound (C) is inhibited by including the dehydrating agent (E) in the composition (II), and thus the storage stability is considered to be improved. In addition, due to a polymerization-initiating ability of the organoborane generated from the complex (A), the compound (D) having a polymerizable group is polymerized to produce a polymer, whereas a urethanization reaction of the compound (B) having a plurality of hydroxy groups with the compound (C) having a plurality of isocyanate groups is caused to produce a polyurethane. It is considered that since the production of the polymer and the production of the polyurethane occur concurrently, the polymer and the polyurethane form an interpenetrated polymer network (TPN) structure or a semi-interpenetrated polymer network structure. As a result, while maintaining the adhesion strength, formation of the adhesion layer superior in flexibility is considered to be enabled. The “interpenetrated polymer network structure” as referred to means a structure in which two or more networks are tangled, the structure being a network structure in which tangling networks cannot be divided without cleavage of chemical bonds. The “semi-interpenetrated polymer network structure” as referred to means a structure including a network structure and a linear or branched polymer, the structure being a network structure in which the linear or branched polymer penetrates the networks, and two networks can be divided without cleavage of chemical bonds, in principle.

In regard to the two-component adhesive, an adhesive of three or more components may be provided by further including another composition containing neither the complex (A) nor compound (C), in addition to the composition (I) and the composition (II).

The composition (I) and the composition (II) are described below.

### Composition (I)

The composition (I) contains the complex (A) and the compound (B). Furthermore, the composition (I) preferably contains a urethanization catalyst (hereinafter, may be also referred to as “(X) urethanization catalyst” or “urethanization catalyst (X)”), and may also contain, within a range not leading to impairment of the effects of the present invention, other component(s) aside from components (A), (B), and (X). The composition (I) may also contain the compound (D) as described later in a section of Composition (II); however, there may be a case in which the storage stability of the two-component adhesive is deteriorated since the polymerizable group of the compound (D) can react with the compound (a) constituting the complex (A), and therefore, it is preferred that the composition (I) contains substantially no compound (D). Moreover, the composition (I) may also contain the dehydrating agent (E) as described later in the section of the Composition (II). Each component is described below.

(A) Complex

The complex (A) is a complex derived from an organoborane and the compound (a). The compound (a) has the group (X) capable of undergoing an addition reaction to the isocyanate group. The complex (A) is typically formed by coordinate bonding, etc., of the group (X) of the compound (a) to the organoborane, and the compound (a) inhibits the polymerization-initiating ability of the organoborane. The organoborane can form the complex (A) by interacting with one or a plurality of compounds (a).

Organoborane

The organoborane is a compound obtained from borane by substituting a hydrogen atom with an organic group. The “organic group” as referred to herein means a group that includes at least one carbon atom. The organoborane is exemplified by a compound represented by the following formula (1), and the like.

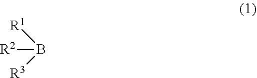

In the above formula (1), R¹, R², and R³ each independently represent a monovalent organic group having 1 to 20 carbon atoms.

The monovalent organic group having 1 to 20 carbon atoms represented by R¹, R² or R³ is exemplified by: a monovalent hydrocarbon group having 1 to 20 carbon atoms; a group (α) that includes a divalent hetero atom-containing group between two adjacent carbon atoms of the hydrocarbon group; a group obtained from the hydrocarbon group or the group (α) by substituting a part or all of hydrogen atoms with a monovalent hetero atom-containing group; and the like.

Exemplary monovalent hydrocarbon groups having 1 to 20 carbon atoms may be a monovalent chain hydrocarbon group having 1 to 20 carbon atoms, a monovalent alicyclic hydrocarbon group having 3 to 20 carbon atoms, a monovalent aromatic hydrocarbon group having 6 to 20 carbon atoms, and the like.

Examples of the monovalent chain hydrocarbon group having 1 to 20 carbon atoms include:

alkyl groups such as a methyl group, an ethyl group, a propyl group, and a butyl group;

alkenyl groups such as an ethenyl group, a propenyl group, and a butenyl group;

alkynyl groups such as an ethynyl group, a propynyl group, and a butynyl group; and the like.

Examples of the monovalent alicyclic hydrocarbon group having 3 to 20 carbon atoms include:

alicyclic saturated hydrocarbon groups such as a cyclopropyl group, a cyclobutyl group, a cyclopentyl group, a cyclohexyl group, a norbornyl group, an adamantyl group, and a tricyclodecyl group;

alicyclic unsaturated hydrocarbon groups such as a cyclopentenyl group, a cyclohexenyl group, a norbornenyl group, and a tricyclodecenyl group; and the like.

Examples of the monovalent aromatic hydrocarbon group having 6 to 20 carbon atoms include:

aryl groups such as a phenyl group, a tolyl group, a xylyl group, a naphthyl group, and an anthryl group;

aralkyl groups such as a benzyl group, a phenethyl group, and a naphthylmethyl group; and the like.

Examples of the hetero atom that may be contained in the monovalent and divalent hetero atom-containing groups include an oxygen atom, a nitrogen atom, a sulfur atom, a phosphorus atom, a silicon atom, and the like.

Examples of the divalent hetero atom-containing group include —O—, —CO—, —NR′—, —S—, —CS—, —SO—, —SO₂—, —POR′₂—, —SiR′₂—, a group obtained by combining the same, and the like. R′ represents a monovalent hydrocarbon group having 1 to 10 carbon atoms.

Examples of the monovalent hetero atom-containing group include —OH, —COOH, —NH₂, —CN, —NO₂, —SH, and the like.

The organoborane is, in light of superior polymerization-initiating ability as well as stability and availability, preferably a compound represented by the above formula (1), wherein R¹ to R³ each represent a hydrocarbon group, more preferably a trialkylborane, still more preferably trimethylborane, triethylborane, tripropylborane, or tributylborane, and particularly preferably triethylborane.

Compound (a)

The compound (a) is a compound having the group (X). The group (X) is capable of undergoing an addition reaction to an isocyanate group. When the composition (I) and the composition (II) are mixed, the compound (a) reacts with the isocyanate group included in the compound (C) contained in the composition (II).

The group (X) is exemplified by a group having active hydrogen that is capable of bonding to a hetero atom (hereinafter, may be also referred to as “group (X1)”), and the like. Examples of such a hetero atom include a nitrogen atom, an oxygen atom, a sulfur atom, a phosphorus atom, and the like.

Examples of the group (X1) include:

an amino group (—NH₂) and a mono-substituted amino group (being derived from —NH₂ by substituting one hydrogen atom with a hydrocarbon group), as a group having active hydrogen capable of bonding to a nitrogen atom;

a hydroxy group as a group having active hydrogen capable of bonding to an oxygen atom;

a sulfanyl group as a group having active hydrogen capable of bonding to a sulfur atom;

a phosphino group (—PH₂) and a mono-substituted phosphino group (being derived from —PH₂ by substituting one hydrogen atom with a hydrocarbon group), as a group having active hydrogen capable of bonding to a phosphorus atom; and the like.

Examples of the compound having an amino group include:

monoamines such as methylamine, ethylamine, propylamine, butylamine, aniline, ethanolamine, cyclopentylamine, and cyclohexylamine;

diamines such as 1,2-di aminoethane, 1,2-diaminopropane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, 4,4′-diaminodiphenylmethane, 4,4′-diaminodiphenyl ether, 4,4′-diaminobenzophenone, 2,2-bis (4-aminophenyl)propane, 2-(3-aminophenyl)-2-(4-aminophenyl)propane, 1,4-bis[1-(4-aminophenyl)-1-methylethyl]benzene, 1,3-bis[1-(4-aminophenyl)-1-methylethyl]benzene, 4,7,10-trioxatridecane-1,13-diamine, 4,9-dioxadodecane-1,12-diamine, and 3,6,9-tri oxaundecane-1,11-di amine;

triamines such as 1,2,3-triaminopropane, 1,2,4-triaminobutane, 1,3,5-triaminocyclohexane, and 1,3,5-triaminobenzene; and the like.

Examples of the compound having a mono-substituted amino group include dimethylamine, diethylamine, dipropylamine, dibutylamine, dicyclopentylamine, dicyclohexylamine, N,N′-dimethyl-1,3-diaminopropane, N,N,N′,N′-tetramethyl-1,3-diaminopropane, diethanolamine, and the like.

Examples of the compound having a hydroxy group include:

monohydric alcohols such as methanol and ethanol;

diols such as ethylene glycol, 1,4-butanediol, and 1,2-cyclohexanediol;

triols such as glycerin and trimethylolpropane; and the like.

Examples of the compound having a sulfanyl group include:

monothiols such as mercaptan and ethanethiol;

dithiols such as ethanedithiol and butanedithiol; and the like.

Examples of the compound having a phosphino group include:

monophosphines such as ethylphosphine and butylphosphine;

diphosphines such as diphosphinoethane and diphosphinobutane; and the like.

Examples of the compound having a mono-substituted phosphino group include diethylphosphine, dibutylphosphine, and the like.

The number of the group (X) included in the compound (a) may be either one, or two or more, and is preferably two or more, more preferably two to four, still more preferably two or three, and particularly preferably two. When the number of the group (X) falls within the above range, a polyurea structure is formed from the compound (a) and the compound (C), consequently leading to a further improvement of the flexibility of the adhesion layer.

The group (X) is, in light of facilitation of the deprotection reaction and a further improvement of the adhesion strength, preferably an amino group, a mono-substituted amino group, a sulfanyl group, a phosphino group, or a mono-substituted phosphino group, more preferably an amino group or a mono-substituted amino group, and still more preferably an amino group.

The compound (a) is, in light of further facilitation of the deprotection reaction with the compound (C), and a further improvement of the adhesion strength, preferably a compound having an amino group, more preferably a diamine or a triamine, still more preferably a diamine, further particularly preferably a diaminoalkane having 2 to 4 carbon atoms, and most preferably 1,3-diaminopropane.

The lower limit of a ratio of the number of the compounds (a) to the number of the organoborane in the complex (A) is preferably 0.5, more preferably 0.7, and still more preferably 0.9. The upper limit of the ratio is preferably 2, more preferably 1.5, and still more preferably 1.1. When the ratio falls within the above range, a further improvement of the stability of the complex (A) is enabled, and as a result, a further improvement of the storage stability of the two-component adhesive is enabled.

The lower limit of a content of the complex (A) in the composition (I) is, in light of a further improvement of the adhesion strength, preferably 0.1% by mass, more preferably 1% by mass, still more preferably 1.5% by mass, and particularly preferably 2% by mass. The upper limit of the content is, in light of ease in handling of the two-component adhesive, preferably 50% by mass, more preferably 30% by mass, still more preferably 15% by mass, and particularly preferably 10% by mass. One, or two or more types of the complex (A) may be used.

(B) Compound

The compound (B) is a compound having a plurality of hydroxy groups (except for those corresponding to the compound (C), described later). By mixing of the composition (I) and the composition (II), the compound (B) produces a polyurethane through a urethanization reaction with the compound (C) having a plurality of isocyanate groups in the composition (11), thereby enabling an adhesion layer superior in flexibility to be formed.

It is preferred that the compound (B) does not have a polymerizable group. Due to not having the polymerizable group, occurrence of a reaction of the compound (B) with the compound (a) in the complex (A) is inhibited, and as a result, storage stability of the composition (I) can be further improved. The compound (B) may also have, in addition to a hydroxy group, a polar functional group other than the isocyanate group.

The compound (B) may be any one of a low-molecular weight compound, an oligomer, and a polymer.

The number of hydroxy groups included in the compound (B) is preferably 2 to 20, more preferably 2 to 10, still more preferably 2 to 6, particularly preferably 2 to 4, and further particularly preferably 2 or 3. When the number of hydroxy groups included in the compound (B) falls within the above range, the strength of the adhesion layer to be formed can be further improved, and as a result, the adhesion strength can be further improved.

The compound (B) is exemplified by a polyhydric alcohol, a polyol compound, and the like.

Examples of the polyhydric alcohol include:

alkanediols such as ethylene glycol, propylene glycol, and 2-butyl-2-ethyl-1,3-propanediol;

alkanetriols such as 1,2,4-butanetriol and trimethylolpropane;

alkanetetraols such as pentaerythritol; and the like.

The polyol compound is exemplified by a polyether polyol, a polyester polyol, a polybutadiene polyol, a polycarbonate polyol, and the like.

An exemplary polyether polyol may be a polyalkylene glycol, a polyalkylene glycol-containing polyol, a bisphenol-containing polyol, and the like.

Examples of the polyalkylene glycol include polyethylene glycol, polypropylene glycol, polytetramethylene glycol, and the like.

Examples of the polyalkylene glycol-containing polyol include a double-end ethylene glycol adduct of a polypropylene glycol represented by the following formula (B-1), a double-end ethylene glycol adduct of polytetramethylene glycol, and the like.

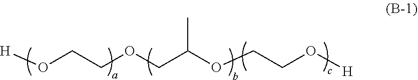

In the above formula (B-1), a, b and c are each independently an integer of 1 to 200.

Examples of the bisphenol-containing polyol include a propylene glycol adduct of bisphenol A represented by the following formula (B-2), an ethylene glycol adduct of bisphenol A, and the like.

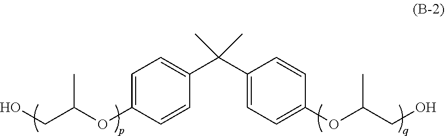

In the above formula (B-2), p and q are each independently an integer of 1 to 200.

An exemplary polyester polyol may be a condensed polyester polyol, a polylactone polyol, and the like.

The condensed polyester polyol is exemplified by a polyester polyol formed from a polyvalent carboxylic acid, an ester or an anhydride thereof, and a polyhydric alcohol compound, and the like.

Examples of the polyvalent carboxylic acid include:

aliphatic polyvalent carboxylic acids such as succinic acid, adipic acid, azelaic acid, sebacic acid, maleic acid, fumaric acid, and cyclohexane-1,4-dicarboxylic acid;

aromatic polyvalent carboxylic acids such as terephthalic acid, isophthalic acid, phthalic acid, trimellitic acid, and pyromellitic acid; and the like.

Examples of the polyhydric alcohol compound include:

ethylene glycol, propylene glycol, diethylene glycol, butylene glycol, neopentyl glycol, 1,6-hexanediol, 3-methyl-1,5-pentanediol, 3,3′-dimethylolheptane, polyoxyethylene glycol, polyoxypropylene glycol, polytetramethylene ether glycol, an ethyleneoxide adduct or a propyleneoxide adduct of bisphenol A, glycerin, and the like.

The polylactone polyol is exemplified by polycaprolactone diol, polycaprolactone triol, polyvalerolactone diol, and the like.

Examples of the polybutadiene polyol include: poly(1,4-butadiene)glycol and hydrogenation products thereof, poly(1,2-butadiene)glycol and hydrogenation products thereof, poly(1,2-/1,4-butadiene)glycol and hydrogenation products thereof, and the like.

Examples of the polycarbonate polyol include polytetramethylene carbonate diol, polypentamethylene carbonate diol, polyhexamethylene carbonate diol, polyhexamethylene carbonate triol, and the like.

Examples of commercially available products of the compound (B) include “EXCENOL 823” (available from AGC Inc.), “WANOL R2303” (available from Wanhua Chemical Co., Ltd.), “NEWPOL PP-1000” (available from Sanyo Chemical Industries, Ltd.), and the like.

The compound (B) is preferably the polyol compound, more preferably the polyether polyol, the polyester polyol, or the polybutadiene polyol, and still more preferably the polyether polyol.

The lower limit of a molecular weight of the compound (B) is, in light of a further improvement of the flexibility of the adhesion layer, preferably 100, more preferably 300, still more preferably 500, and particularly preferably 1,000. The upper limit of the molecular weight is preferably 20,000, more preferably 10,000, still more preferably 8,000, and particularly preferably 6,000. In a case in which the compound (B) has molecular weight distribution with the oligomer, polymer, and/or the like, the molecular weight is, for example, a number average molecular weight.

The lower limit of a ratio of the number of hydroxy groups of the compound (B) to the number of isocyanate groups of the compound (C) is preferably 0.1, more preferably 0.5, and still more preferably 0.7. The upper limit of the ratio is preferably 10, more preferably 5, and still more preferably 3. When the ratio falls within the above range, the polyurethane is more effectively formed from the compound (B) and the compound (C); therefore, the flexibility of the adhesion layer can be further improved. The number of isocyanate groups and the number of hydroxy groups each mean an average value in the compound (C) and the compound (B).

The lower limit of a content of the compound (B) in the composition (I) is preferably 30% by mass, more preferably 50% by mass, still more preferably 75% by mass, and particularly preferably 85% by mass. The upper limit of the content is preferably 99.9% by mass, more preferably 99% by mass, still more preferably 98% by mass, and particularly preferably 97% by mass. When the content of the compound (B) falls within the above range, the flexibility of the adhesion layer can be further improved. One, or two or more types of the compound (B) may be used.

The lower limit of a ratio of a mass of the compound (B) to a mass of the complex (A) in the composition (I) is preferably 1, more preferably 5, still more preferably 8, and particularly preferably 10. The upper limit of the ratio is preferably 200, more preferably 100, still more preferably 70, and particularly preferably 50.

(X) Urethanization Catalyst

The urethanization catalyst (X) is a substance that promotes the urethanization reaction of the compound (B) and the compound (C). Due to the composition (I) containing the urethanization catalyst (X), a rate of the urethanization reaction of the compound (B) and the compound (C) that occurs when the composition (1) and the composition (II) are mixed can be further accelerated, and as a result, the flexibility of the adhesion layer can be further improved.

The urethanization catalyst (X) is exemplified by a tertiary amine, a quaternary ammonium salt, a carboxylic acid salt, an organic metal compound, and the like.

Examples of the tertiary amine include 1,4-diazabicyclo[2.2.2]octane, diazabicycloundecene, bis(N,N-dimethylamino-2-ethyl)ether, N,N,N′,N′-tetramethylhexamethylenediamine, N-methylmorpholine, and the like.

Examples of the quaternary ammonium salt include tetraethylammonium hydroxide, and the like.

Examples of the carboxylic acid salt include potassium acetate, potassium octylate, and the like.

Examples of the organic metal compound include:

organic tin compounds such as tin acetate, tin octylate, tin oleate, tin laurylate, dibutyltin diacetate, dimethyltin dilaurate, dibutyltin dilaurate, dibutyltin dimercaptide, dibutyltin maleate, dibutyltin dilaurate, dibutyltin dineodecanoate, dioctyltin dimercaptide, dioctyltin dilaurylate, and dibutyltin dichloride;

organic lead compounds such as lead octanoate and lead naphthenate;

organic nickel compounds such as nickel naphthenate;

organic cobalt compounds such as cobalt naphthenate;

organic copper compounds such as copper octanoate;

organic bismuth compounds such as bismuth octylate; and the like.

In the case in which the composition (I) contains the urethanization catalyst (X), the lower limit of a content of the urethanization catalyst (X) in the composition (I) is preferably 0.01% by mass, more preferably 0.1% by mass, and still more preferably 0.2% by mass. The upper limit of the content is preferably 10% by mass, more preferably 5% by mass, and still more preferably 2% by mass. When the content of the urethanization catalyst (X) falls within the above range, the polyurethane can be more effectively produced from the compound (B) and the compound (C), and as a result, the flexibility of the adhesion layer can be further improved. One, or two or more types of the urethanization catalyst (X) may be used.

Other Component(s)

The composition (I) may contain, as other component(s) aside from the components (A) and (B) and the urethanization catalyst (X), for example, an inorganic filler, a polymer component, a plasticizer, a colorant and/or the like. One, or two or more types of the other component may be employed.

Examples of the inorganic filler include alumina, silica, titanium dioxide, calcium carbonate, talc, and the like.

Polymer Component

The polymer component is exemplified by a polyolefin, a polystyrene, a styrene copolymer, a poly(meth)acrylate, a polydiene, an acryl copolymer, a thermoplastic elastomer, and the like. Alternatively, an ethylene-vinyl acetate copolymer, an epoxy resin, a phenol resin, a silicone resin, a polyester resin, a urethane resin, etc. may be also used. Furthermore, a copolymer having a structure of the polymer described above may be suitably used as the polymer component.

The polymer component may be a polymer particle, or a polymer not forming a particle.

In the case in which the composition (I) contains the polymer component, the upper limit of a content of the polymer component in the composition (1) is preferably 50% by mass, more preferably 20% by mass, and still more preferably 5% by mass. The lower limit of the content is, for example, 0.1% by mass.

Examples of the plasticizer include:

phthalic acid esters such as dibutyl phthalate, di(2-ethylhexyl) phthalate, and butylbenzyl phthalate;

non-aromatic dibasic acid esters such as dioctyl adipate and dioctyl sebacate;

benzoic acid esters such as dipropylene glycol dibenzoate and triethylene glycol dibenzoate; and the like.

Examples of the colorant include carbon black, and the like.

### Composition (II)

The composition (II) contains the compound (C), the compound (D), and the dehydrating agent (E). The composition (II) contains preferably a polymerization inhibitor (Y), and may also contain other component(s) aside from the components (C), (D), and (Y), within a range not leading to impairment of the effects of the present invention. Each component is described below.

(C) Compound

The compound (C) is a compound having a plurality of isocyanate groups. The compound (C) undergoes a deprotection reaction with the compound (a) constituting the complex (A) in the composition (I) to form a deprotection reaction product (p). As described above, when the composition (I) and the composition (II) are mixed upon use of the two-component adhesive, the group (X) capable of undergoing an addition reaction to the isocyanate group of the compound (a) in the complex (A) reacts to the isocyanate group of the compound (C), whereby the deprotection reaction product (p) and the organoborane are produced. Thus, the adhesion proceeds through polymerization of the compound (D) having the polymerizable group, due to the polymerization-initiating ability of the organoborane. Also, when the composition (I) and the composition (II) are mixed, the compound (C) undergoes the urethanization reaction with the compound (B) having a plurality of hydroxy groups in the composition (I) to produce a polyurethane, thereby enabling an adhesion layer superior in flexibility to be formed.

It is preferred that the compound (C) does not have a polymerizable group. Furthermore, the compound (C) may also have a polar functional group in addition to the isocyanate group.

The compound (C) may be any one of a low-molecular weight compound, an oligomer, and a polymer.

The number of isocyanate groups included in the compound (C) is preferably 2 to 20, more preferably 2 to 10, still more preferably 2 to 6, particularly preferably 2 to 4, and further particularly preferably 2 or 3.

The compound (C) is exemplified by an aromatic or aliphatic polyisocyanate, a prepolymer having at an end thereof a plurality of isocyanate groups that is a reaction product of the polyisocyanate and a polyol, and the like.

Examples of the aromatic polyisocyanate include:

aromatic diisocyanates such as diphenylmethane diisocyanate (MDI), tolylene diisocyanate (TDI), carbodiimide-modified diphenylmethane diisocyanate (carbodiimide-modified MDI, and di(isocyanatophenylmethylphenyl)carbodiimide);

aromatic triisocyanates such as triphenylmethane triisocyanate and dimethylene triphenylene triisocyanate;

aromatic tetraisocyanates such as benzene-1,2,4,5-tetraisocyanate;

mixed aromatic polyisocyanates each having 2 to 4 NCOs, such as polymethylenepolyphenylene polyisocyanate (crude MDI); and the like.

Examples of the aliphatic polyisocyanate include:

aliphatic diisocyanates such as tetramethylene diisocyanate, hexamethylene diisocyanate, undecane diisocyanate, dodecane diisocyanate, tridecane diisocyanate, methylene di(1,4-cyclohexyleneisocyanate), isophorone diisocyanate, cyclohexane-1,4-diisocyanate, tri(1,4-cyclohexylene) diisocyanate, propylene-1,3-di(1,4-cyclohexyleneisocyanate), norbornene diisocyanate (NBDI), and m-xylene diisocyanate;

aliphatic triisocyanates such as 1,3,6-hexamethylene triisocyanate, 1,6,11-undecane triisocyanate, cyclohexane-1,3,5-triisocyanate, and tricyclohexylmethane triisocyanate;

aliphatic trifunctional isocyanates such as trimers (isocyanurate form), burettes, allophanate bonds, and adducts of an aliphatic diisocyanate, such as hexamethylene diisocyanate and isophorone diisocyanate;

aliphatic tetraisocyanates such as cyclohexane-1,2,4,5-tetraisocyanate; and the like.

The polyol for use in forming the prepolymer having at an end thereof a plurality of isocyanate groups that is a reaction product of the aromatic or aliphatic polyisocyanate and a polyol is exemplified by the polyol compounds exemplified as the compound (B), and the like.

Examples of commercially available products of the compound (C) include: “WANNATE PM-200” (crude MDI) and “WANNATE CDMDI” (carbodiimide-modified MDI) both available from Wanhua Chemical Co., Ltd.; “DURANATE TPA-100” (isocyanurate form of hexamethylene diisocyanate) available from Asahi Kasei Corporation; “TAKENATE 500” (m-xylene diisocyanate) available from Mitsui Chemicals, Inc.; and the like.

As the compound (C), the aromatic isocyanate or aliphatic isocyanate is preferred.

The lower limit of a content of the compound (C) in the composition (II) is preferably 1% by mass, more preferably 5% by mass, still more preferably 10% by mass, and particularly preferably 15% by mass. The upper limit of the content is preferably 60% by mass, more preferably 50% by mass, still more preferably 40% by mass, and particularly preferably 35% by mass. When the content of the compound (C) falls within the above range, the flexibility of the adhesion layer can be further improved. One, or two or more types of the compound (C) may be used.

(D) Compound

The compound (D) is a compound having a polymerizable group. The “polymerizable group” as referred to means a group that is capable of allowing for a polymerization reaction such as radical polymerization. The compound (D) is polymerized to produce a polymer due to a polymerization-initiating ability of the organoborane generated from the complex (A).

Examples of the polymerizable group include:

carbon-carbon double bond-containing groups such as a vinyl group, an allyl group, a styryl group, and a (meth)acryloyl group;

carbon-carbon triple bond-containing groups such as an ethynyl group and a propargyl group; and the like.

Of these, in light of being highly polymerizable and capable of accelerating a curing speed, the carbon-carbon double bond-containing group is preferred, and a (meth)acryloyl group is more preferred.

The number of the polymerizable groups included in the compound (D) is, in light of a further increase in polymerization rate, preferably 1 to 3, more preferably 1 or 2, and still more preferably 1.

Examples of the compound (D) include, as compounds each having one polymerizable group:

olefins such as butene, pentene, hexene, octene, decene, and dodecene;

styrene compounds such as styrene, α-methylstyrene, and methyl styrene;

vinyl carboxylates such as vinyl acetate, vinyl propionate, and vinyl laurate;

halogenated olefins such as vinyl chloride and vinylidene chloride;

vinyl compounds such as methyl vinyl ketone and methyl vinyl ether;

alkyl (meth)acrylates such as methyl (meth)acrylate, ethyl (meth)acrylate, n-butyl (meth)acrylate, sec-butyl (meth)acrylate, tert-butyl (meth)acrylate, and 2-ethylhexyl (meth)acrylate;

(meth)acrylates having an aliphatic ring, e.g., cycloalkyl (meth)acrylates such as cyclopentyl (meth)acrylate, cyclohexyl (meth)acrylate, 4-butylcyclohexyl (meth)acrylate, bornyl (meth)acrylate, isobornyl (meth)acrylate, tricyclodecan-yl (meth)acrylate, and tetracyclododecan-yl (meth)acrylate, as well as cycloalkenyl (meth)acrylates such as cyclopentenyl (meth)acrylate, cyclohexenyl (meth)acrylate, and tricyclodecen-yl (meth)acrylate;

(meth)acrylates having an aromatic ring, e.g., aryl (meth)acrylates such as phenyl (meth)acrylate and tolyl (meth)acrylate, aralkyl (meth)acrylates such as benzyl (meth)acrylate, as well as aryloxyalkyl (meth)acrylates such as phenoxyethyl (meth)acrylate;

(meth)acrylate compounds, e.g., hetero atom-containing (meth)acrylates such as hydroxyethyl (meth)acrylate, glycidyl (meth)acrylate, and tetrahydrofurfuryl (meth)acrylate;

(meth)acrylamide compounds such as (meth)acrylamide and N-methyl(meth)acrylamide;

(meth)acrylonitrile; and the like.

As the compound (D), crosslinkable compounds each having two or more polymerizable groups, and the like may be also exemplified.

Examples of the crosslinkable compound include:

chain glycol-based crosslinkable compounds such as ethylene glycol di(meth)acrylate and triethylene glycol di(meth)acrylate;

alicyclic glycol-based crosslinkable compounds such as tricyclodecanediyl di(meth)acrylate;

trimethylolpropane-based crosslinkable compounds such as trimethylolpropane tri(meth)acrylate;

bisphenol-based crosslinkable compounds such as bisphenol A bis(polyethylene glycol (meth)acrylate);

isocyanurate-based crosslinkable compounds such as tri(N-hydroxyethyl)isocyanurate di(meth)acrylate;

urethane-based crosslinkable compounds such as a compound represented by the following formula (2);

end bismaleimide-modified polyimide-based crosslinkable compounds such as a compound represented by the following formula (3); and the like.

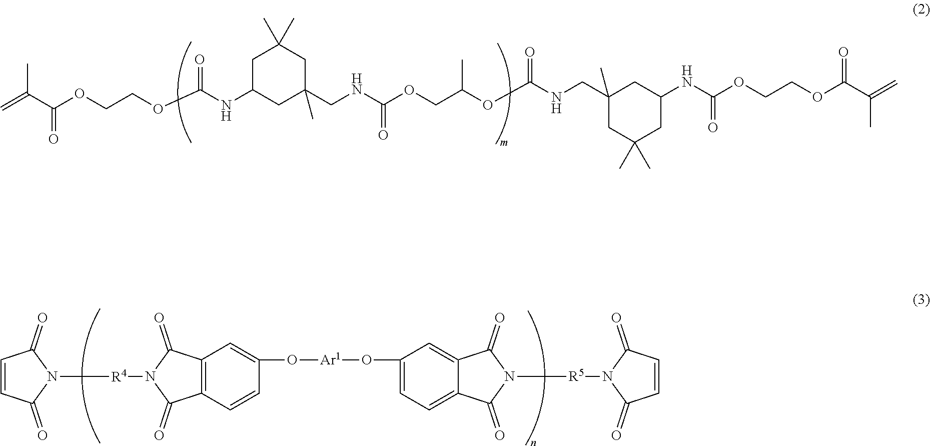

In the above formula (2), m is an integer of 1 to 20.

In the above formula (3), n is an integer of 1 to 20; R⁴ and R⁵ each independently represent an alkylene group having 1 to 20 carbon atoms; and Ar¹ represents an arylene group having 6 to 20 carbon atoms, wherein in a case in which n is no less than 2, a plurality of R⁴s are identical or different, and a plurality of Ar's are identical or different.

Of these, in light of more superior polymerizability, the compound (D) is preferably the (meth)acrylate compound. Among them, in light of reduction of odor of the two-component adhesive, the hetero atom-containing (meth)acrylate is preferred, and tetrahydrofurfuryl (meth)acrylate is more preferred.

The lower limit of a content of the compound (D) in the composition (II) is preferably 10% by mass, more preferably 50% by mass, still more preferably 60% by mass, and particularly preferably 70% by mass. The upper limit of the content is preferably 99% by mass, more preferably 95% by mass, still more preferably 90% by mass, and particularly preferably 87% by mass. When the content of the compound (D) falls within the above range, the strength of the adhesion layer can be further improved, and as a result, the adhesion strength can be further improved. One, or two or more types of the compound (D) may be used.

The lower limit of a ratio of a mass of the compound (D) to a mass of the compound (C) in the composition (II) is preferably 0.1, more preferably 1, still more preferably 1.5, and particularly preferably 2. The upper limit of the ratio is preferably 30, more preferably 20, still more preferably 15, and particularly preferably 10. When the ratio of the mass of the compound (D) to the mass of the compound (C) falls within the above range, the flexibility of the adhesion layer can be further improved.

(E) Dehydrating Agent

The dehydrating agent (E) as referred to herein means a substance that is capable of removing moisture present in a material. Therefore, due to the composition (TI) containing the dehydrating agent (E), moisture with which a system has been contaminated from outside during storage can be removed. The composition (II) containing the dehydrating agent (E) allows the two-component adhesive to be superior in storage stability.

The dehydrating agent (E) is exemplified by an inorganic dehydrating agent, an organic dehydrating agent, and the like.

Examples of the inorganic dehydrating agent include:

zeolites such as zeolite 3A, zeolite 4A, and zeolite 5A;

anhydrous inorganic salts such as anhydrous calcium chloride, anhydrous sodium sulfate, anhydrous calcium sulfate, anhydrous magnesium chloride, anhydrous magnesium sulfate, anhydrous potassium carbonate, anhydrous potassium sulfide, anhydrous potassium subsulfide, anhydrous sodium sulfite, and anhydrous copper sulfate;

silica gel, alumina, silica alumina, activated clay; and the like.

Examples of the organic dehydrating agent include:

carboxylic acid orthoesters, e.g.,

orthoformic acid esters such as methyl orthoformate, ethyl orthoformate, and propyl orthoformate;

orthoacetic acid esters such as methyl orthoacetate, ethyl orthoacetate, and propyl orthoacetate;

orthopropionic acid esters such as methyl orthopropionate and ethyl orthopropionate;

acetal compounds such as benzaldehyde dimethyl acetal, acetaldehyde dimethyl acetal, formaldehyde dimethyl acetal, acetone dimethyl acetal, acetone dibenzyl acetal, diethyl ketone dimethyl acetal, benzophenone dimethyl acetal, benzylphenyl ketone dimethyl acetal, cyclohexanone dimethyl acetal, acetophenone dimethyl acetal, 2,2-dimethoxy-2-phenylacetophenone, 4,4-dimethoxy-2,5-cyclohexadien-1-one acetal, and dimethyl acetamide diethyl acetal;

carbodiimide compounds such as dicyclohexylcarbodiimide and diisopropylcarbodiimide;

silicate compounds such as methyl silicate and ethyl silicate, and the like.

With regard to dehydrating agent (E), in light of a possible further improvement of the strength of the adhesion layer, thereby consequently enabling the adhesion strength to be further improved, the inorganic dehydrating agent is preferred, and the zeolite is more preferred. Furthermore, of the zeolites, in light of a further improvement of the storage stability, zeolite 3A or zeolite 5A is preferred, and zeolite 3A is more preferred.

The lower limit of a content of the dehydrating agent (E) in the composition (II) is preferably 0.1% by mass, more preferably 0.5% by mass, still more preferably 1% by mass, and particularly preferably 2% by mass. The upper limit of the content is preferably 20% by mass, more preferably 10% by mass, still more preferably 6% by mass, and particularly preferably 4% by mass. When the content of the dehydrating agent (E) falls within the above range, the storage stability of the two-component adhesive can be further improved. One, or two or more types of the dehydrating agent (E) may be used.

The lower limit of a ratio of a mass of the dehydrating agent (E) to a mass of the compound (C) in the composition (II) is preferably 0.001, more preferably 0.05, still more preferably 0.08, and particularly preferably 0.1. The upper limit of the ratio is preferably 2, more preferably 1.5, still more preferably 1, and particularly preferably 0.5. When the ratio of the mass of the dehydrating agent (E) to the mass of the compound (C) falls within the above range, the storage stability of the two-component adhesive can be further improved.

(Y) Polymerization Inhibitor

The polymerization inhibitor (Y) as referred to herein means a substance that is capable, by capturing a generated radical, of terminating polymerization of a compound or the like having a polymerizable group during storage, thereby converting the same into a stable radical, or the like. When the composition (II) contains the polymerization inhibitor (Y), the storage stability of the two-component adhesive can be further improved.

The polymerization inhibitor (Y) is exemplified by an organic-based polymerization inhibitor, an inorganic-based polymerization inhibitor, an organic salt-based polymerization inhibitor, and the like.

Examples of the organic-based polymerization inhibitor include:

phenol-based polymerization inhibitors such as hydroquinone, tert-butylhydroquinone, hydroquinone monomethyl ether, 2,2′-methylene-bis(4-methyl-6-tert-butylphenol), catechol, 2,6-di-tert-butyl-4-methylphenol (BHT), 2,4,6-tri-tert-butylphenol, 4-tert-butylcatechol, and 4,4′-thiobis[ethylene(oxy)(carbonyl)(ethylene)]bis[2,6-bis(1,1-dimethylethyl)phenol];

quinone-based polymerization inhibitors such as benzoquinone;

phenothiazine-based polymerization inhibitors such as phenothiazine, bis(α-methylbenzyl)phenothiazine, 3,7-dioctylphenothiazine, and bis(α,α-dimethylbenzyl)phenothiazine;

N-oxyl-based polymerization inhibitors such as 2,2,6,6-tetramethylpiperidine-1-oxyl, 4-hydroxy-2,2,6,6-tetramethylpiperidine-1-oxyl, 4-oxo-2,2,6,6-tetramethylpiperidine-1-oxyl, and 4-methoxy-2,2,6,6-tetramethylpiperidine-1-oxyl; and the like.

Examples of the inorganic-based polymerization inhibitor include copper chloride, copper sulfate, iron sulfate, and the like.

Examples of the organic salt-based polymerization inhibitor include copper butyldithiocarbamate, N-nitroso-N-phenylhydroxylamineammonium, an N-nitroso-N-phenylhydroxylaminealuminum salt, and the like.

Of these, the phenol-based polymerization inhibitor or the phenothiazine-based polymerization inhibitor is preferred, and 2,6-di-tert-butyl-4-methylphenol or phenothiazine is more preferred.

In the case in which the composition (II) contains the polymerization inhibitor (Y), the lower limit of a content of the polymerization inhibitor (Y) with respect to the composition (II) is preferably 0.001% by mass, more preferably 0.01% by mass, still more preferably 0.03% by mass, and particularly preferably 0.05% by mass. The upper limit of the content is preferably 10% by mass, more preferably 1% by mass, still more preferably 0.5% by mass, and particularly preferably 0.2% by mass. When the content of the polymerization inhibitor (Y) falls within the above range, the storage stability of the two-component adhesive can be further improved. One, or two or more types of the polymerization inhibitor (Y) may be used.

Other Component(s)

The composition (II) may also contain, as other component(s) aside from the compound (C), the compound (D), and the polymerization inhibitor (Y), for example, an inorganic filler, a polymer component, a plasticizer, a colorant, and the like. One, or two or more types of each the other component(s) may be used.

Details and preferred examples of the inorganic filler, the polymer component, the plasticizer, and the colorant as the other component(s) in the composition (II) are similar to those for the other component(s) in the composition (I).

### Preparation Method of Two-Component Adhesive

The two-component adhesive may be obtained by, for example, mixing the complex (A), the compound (B) and if necessary, the other component(s) to prepare the composition (I), and separately mixing the compound (C), the compound (D), and the dehydrating agent (E), as well as, if necessary, the other component(s) to prepare the composition (II).

### Method of Using Two-Component Adhesive

The two-component adhesive may be used by a well-known method. Upon an adhesion operation, the composition (I) and the composition (II) are mixed first to prepare a mixture (hereinafter, may be also referred to as “mixture (A)”) of the composition (I) and the composition (II).

In preparing the mixture (A), a ratio of a mass of the composition (II) to a mass of the composition (I) may be appropriately selected such that, for example, a content of the component (A) in the mixture (A), a mass ratio of components (B) to (D) in the mixture (A), and/or the like can fall under a desired value immediately after mixing (provided that no reaction of the components (A) to (D) occurs). The lower limit of the ratio of the mass of the composition (IT) to the mass of the composition (I) is preferably 0.1, more preferably 1, still more preferably 2, and particularly preferably 2.3. The upper limit of the ratio is preferably 30, more preferably 10, still more preferably 8, and particularly preferably 7. The two-component adhesive can be used by a system through discharging with a preexisting or commercially available cartridge, and mixing by means of a static mixer, thereby enabling a further improvement in workability.

Next, the mixture (A) thus obtained is applied on one adherend, and thereafter another adherend is, for example, overlaid onto the mixture (A) applied so as to be in close contact, thereby forming an adhesion layer between both adherends to enable adhesion.

Alternatively, after the mixture (A) is applied on both adherends, these applied mixtures (A) may be brought into close contact. Examples of the adherend include: resinous materials such as polypropylene (PP), polyethylene (PE), polyphenylene sulfide (PPS), polyamide 6 (PA6), and polyamide 66 (PA66); metal materials such as stainless steel (SUS), hot-dip galvanized steel (SGHC), and electrodeposited steel (ED); and the like. Of these, the same type or different types of materials may be employed, and thus: adhesion of resinous materials with one another; adhesion of metal materials with one another; and adhesion of the resinous material and the metal material are enabled. The lower limit of a thickness of the adhesion layer formed between both adherends is preferably 0.01 mm, more preferably 0.05 mm, and still more preferably 0.1 mm. The upper limit of the thickness is preferably 5 mm, more preferably 3 mm, and still more preferably 1 mm.

The lower limit of an amount of the complex (A) blended in the composition (I) with respect to a total mass of the composition (I) and the composition (II) used in preparing the mixture (A) is preferably 0.01% by mass, more preferably 0.1% by mass, still more preferably 0.3% by mass, and particularly preferably 0.5% by mass. The upper limit of the amount is preferably 10% by mass, more preferably 7% by mass, still more preferably 5% by mass, and particularly preferably 3% by mass.

The lower limit of an amount of boron atoms blended in the composition (1) with respect to the total mass of the composition (I) and the composition (II) used in preparing the mixture (A) is preferably 0.01% by mass, more preferably 0.1% by mass, still more preferably 0.2% by mass, and particularly preferably 0.4% by mass. The upper limit of the amount is preferably 5% by mass, more preferably 1% by mass, still more preferably 0.5% by mass, and particularly preferably 0.2% by mass.

When the amount of the complex (A) or boron atoms blended for use in preparing the mixture (A) falls within the above range, polymerization of the compound (D) can more appropriately proceed, and as a result, the adhesion strength and the flexibility of the adhesion layer can be further improved.

The lower limit of an amount of the compound (D) blended in the composition (II) with respect to the total mass of the composition (I) and the composition (II) used in preparing the mixture (A) is preferably 10% by mass, more preferably 25% by mass, still more preferably 35% by mass, and particularly preferably 40% by mass. The upper limit of the amount is preferably 90% by mass, more preferably 80% by mass, still more preferably 75% by mass, and particularly preferably 70% by mass.

The lower limit of a total amount of the compound (B) blended in the composition (I) and the compound (C) blended in the composition (II) with respect to the total mass of the composition (I) and the composition (II) used in preparing the mixture (A) is preferably 3% by mass, more preferably 5% by mass, still more preferably 10% by mass, and particularly preferably 15% by mass. The upper limit of the total amount is preferably 90% by mass, more preferably 70% by mass, still more preferably 60% by mass, and particularly preferably 50% by mass.

Provided that a mass of the compound (D) in the composition (II) used in preparing the mixture (A) is X, and that a total mass of the compound (B) in the composition (I) and the compound (C) in the composition (II) is Y, the lower limit of a value X/(X+Y) is preferably 0.01, more preferably 0.1, still more preferably 0.25, particularly preferably 0.4, further particularly preferably 0.45, and most preferably 0.5. The upper limit of the value X/(X+Y) is preferably 0.99, more preferably 0.95, still more preferably 0.9, particularly preferably 0.85, further particularly preferably 0.8, and most preferably 0.7. When the value X/(X+Y) falls within the above range, it is considered that the interpenetrated polymer network structure or the semi-interpenetrated polymer network structure is more efficiently formed from the components (B) to (D), and as a result, the adhesion strength and the flexibility of the adhesion layer can be further improved.

The lower limit of a ratio of the mass of the complex (A) in the composition (1) to the mass of the compound (D) in the composition (II) used in preparing the mixture (A) is preferably 0.001, more preferably 0.005, still more preferably 0.008, and particularly preferably 0.01. The upper limit of the ratio is preferably 0.05, more preferably 0.04, still more preferably 0.035, and particularly preferably 0.03.

Adhesion Layer

The adhesion layer formed by applying the mixture (A) is superior in flexibility. In the adhesion layer, due to concurrent production of: the polyurethane having a network structure produced from the compound (B) having a plurality of hydroxy groups and the compound (C) having a plurality of isocyanate groups; and the polymer produced from the compound (D), it is considered that an interpenetrated polymer network structure or a semi-interpenetrated polymer network structure is formed, and as a result, the adhesion layer can have superior flexibility, while maintaining the adhesion strength.

In the adhesion layer, forming of the interpenetrated polymer network structure or the semi-interpenetrated polymer network structure can be detected from, for example: the polyurethane and the polymer having been produced in the adhesion layer, being in a mutually soluble state without causing phase separation; measurement of dynamic viscoelasticity of the adhesion layer, with a peak of tan δ being uni-modal; and the like.

The flexibility of the adhesion layer is recognized to be superior when values of each of maximum point stress, deformation at break and a modulus of elasticity of the adhesion layer exceed a respective certain value. A test piece produced from the adhesion layer formed by curing of the adhesive obtained by mixing the composition (I) and the composition (II) is subjected to a tensile test until the resin is broken. A value obtained by dividing a maximum load attained until breaking by a cross sectional area of a center of the test piece may be determined as the maximum point stress (MPa). A value obtained from a displacement magnitude at break by dividing by an initial distance between chucks and then multiplying by 100 may be determined as the deformation at break (%). A slope of a stress immediately after start of applying tension may be determined as the modulus of elasticity (MPa).

The lower limit of the maximum point stress of the adhesion layer is preferably 5 MPa, and more preferably 10 MPa. The upper limit of the maximum point stress is, for example, 30 MPa.

The lower limit of the deformation at break of the adhesion layer is preferably 20%, more preferably 50%, and still more preferably 100%. The upper limit of the deformation at break is, for example, 500%.

The lower limit of the modulus of elasticity of the adhesion layer is preferably 50 MPa, and more preferably 100 MPa. The upper limit of the modulus of elasticity is, for example, 1,000 MPa.

### EXAMPLES

Hereinafter, the present invention is explained in detail by way of Examples, but the present invention is not in any way limited to these Examples.

### Preparation of Two-Component Adhesive

Each component used in preparing the composition (I) and the composition (II) of the two-component adhesive is shown below.

(A) Complex

TEB-DAP: “TEB-DAP” available from Callery, LLC (a complex derived from triethylborane and diaminopropane)

(B) Compound

EXCENOL 823: “EXCENOL 823” available from AGC Inc. (polyether polyol, number average molecular weight: 5,100; average number of hydroxyl groups: 3)

WANOL R2303: “WANOL R2303” available from Wanhua Chemical Co., Ltd. (glycerol initiated polyether triol, hydroxyl value: 560 mg KOH/g)

PP1000: “NEWPOL PP-1000” available from Sanyo Chemical Industries, Ltd. (diol (linear liquid type), number average molecular weight: 1,000; hydroxyl value: 112 mg KOH/g)

(C) Compound

PM-200: “WANNATE PM-200” available from Wanhua Chemical Co., Ltd. (crude MDI, number of functional groups: 2.6 to 2.7)

CDMDI: “WANNATE CDMDI” available from Wanhua Chemical Co., Ltd. (carbodiimide-modified MDI)

DURANATE TPA-100: “DURANATE TPA-100” available from Asahi Kasei Corporation (isocyanurate form of hexamethylene diisocyanate)

TAKENATE 500: “TAKENATE 500” available from Mitsui Chemicals, Inc. (m-xylene diisocyanate)

(D) Compound

“LIGHT ESTER THF” available from THFMA: Kyoeisha Chemical Co., Ltd.

(E) Dehydrating Agent

Zeolite 3a: “Molecular Sieve 3A” available from Union Showa K.K.

(X) Urethanization Catalyst

TEDA: “TEDA” (triethylenediamine) available from Air Products & Chemicals Inc.

(Y) Polymerization Inhibitor

BHT: “2,6-di-tert-butyl-p-cresol” available from Tokyo Chemical Industry Co., Ltd.

TDP: “TDP” (phenothiazine) available from Kawaguchi Chemical Industry Co., Ltd.

Inorganic Filler

R202: “AEROSIL R202” (hydrophobic fumed silica) available from Nippon Aerosil Co., Ltd.

NS600: “NS600” (calcium carbonate) available from Nitto Funka Kogyo K.K.

NCO-Containing Methacrylate

MOI: “Karenz MOI” (2-isocyanato ethylmethacrylate) available from Showa Denko K.K.

### Example 1: Preparation of Two-Component Adhesive (E-1)

Preparation of Composition (I)

Preparation of Composition (I-1)

Into a plastic vessel were charged 2.6 parts by mass of “TEB-DAP” as the complex (A), 38.6 parts by mass of “EXCENOL 823”, 17.8 parts by mass of “WANOL R2303” and 38.6 parts by mass of “PP1000” as the compound (B), 0.5 parts by mass of “TEDA” as the urethanization catalyst (X), and 2.0 parts by mass of “R202” as the inorganic filler, which were then mixed to prepare a composition (I-1).

Preparation of Composition (II)

Preparation of composition (II-1)

Into a separable flask equipped with a stirrer were charged 16.3 parts by mass of “PM-200” and 16.3 parts by mass of “CDMDI” as the compound (C), 62.3 parts by mass of “THFMA” as the compound (D), 3.0 parts by mass of “zeolite 3A” as the dehydrating agent (E), 0.1 parts by mass of “BHT” as the polymerization inhibitor (Y), and 2.0 parts by mass of “R202” as the inorganic filler, which were then mixed by stirring for 1 hour. The mixture was thereafter subjected to degassing under reduced pressure for 2 hrs to prepare a composition (II-1).

### Examples 2 to 11 and Comparative Example 1: Preparation of Two-Component Adhesives (E-2) to (E-11) and (CE-1)

Preparation of Composition (I)

Preparation of compositions (I-2) to (I-11) and (CI-1)

Compositions (I-2) to (I-11) and (CI-1) were prepared in a similar manner to the preparation of the composition (1-1) of the Example 1 described above except that each component of the type and in the amount shown in Table 1 below was used.

Preparation of Composition (II)

Preparation of compositions (II-2) to (II-11) and (CII-1) Compositions (II-2) to (II-11) and (CII-1) were prepared in a similar manner to the preparation of the composition (II-1) of the Example 1 described above except that each component of the type and in the amount shown in Table 1 below was used. In Table 1, “-” for each component denotes that the corresponding component was not used.

### Comparative Example 2: Preparation of Two-Component Adhesive (CE-2)

As the composition (CI-2), 100 parts by mass of “TEB-DAP” as the complex (A) were used.

Preparation of composition (CII-2)

Into a separable flask equipped with a stirrer were charged 89.4 parts by mass of “THFMA” as the compound (D), 3.0 parts by mass of “zeolite 3A” as the dehydrating agent (E), and 7.6 parts by mass of “MOI,” being an NCO-containing methacrylate, which were then mixed by stirring for 1 hour. The mixture was thereafter subjected to degassing under reduced pressure for 2 hrs to prepare a composition (CII-2).

### Evaluations

Each two-component adhesive was evaluated on the adhesion strength, the flexibility of the adhesion layer and the storage stability.

Adhesion Strength

Each two-component adhesive prepared as described above was used to provide a test piece for adhesion strength measurement in accordance with the following method, and the adhesion strength (shear strength) was measured in accordance with a shearing test described below. The results of the evaluation are shown together in Table 1 below.

Production of Test Piece for Adhesion Strength Measurement

Two adherends (each having a length of 2.5 cm and a width of 10 cm) were provided, and immediately before applying each of the adhesives thereon, stains on the surface were removed by using a paper wiper (“Kimwipe” available from NIPPON PAPER CRECIA Co., LTD.) soaked with acetone. Next, the composition (I) and the composition (II) were mixed by a bag-mixing procedure. More specifically, the composition (I) and the composition (II) were each weighed into a polyethylene bag such that a mixing ratio of the composition (I): a mixing ratio of the composition (II) became as shown in Table 1 below, and the bag was sealed. Thereafter, the bag was rotated for 1 min on the palm of a hand to permit homogenous mixing. Next, a corner of the bag was cut with scissors, and the mixed adhesive was uniformly applied on one adherend on a portion being 1.25-cm square. In order to give a certain thickness of the adhesive, glass beads having a diameter of 0.25 mm were placed to be interposed, and then another adherend was overlaid thereon to produce a test piece for adhesion strength measurement. As the adherend, a test piece for adhesion strength measurement was produced for a case of a glass fiber-reinforced polypropylene/glass fiber-reinforced polypropylene (GFPP/GFPP), or an electrodeposited steel/electrodeposited steel (ED/ED).

Shear Test

The tensile shear strength at the adhered portion of the test piece for adhesion strength measurement produced as described above was measured by using a tensile tester (“Autograph AG5000B” available from Shimadzu Corporation) in accordance with JIS-K6850. The measurement condition involved a temperature of 23° C., a distance between chucks of 110 mm, and a test speed of 5 mm/min. In addition, each fracture mode was evaluated by visual inspection. The fracture mode indicates each of AF: interfacial fracture, SF: substrate fracture, and CF: coagulation fracture. The adhesion strength (MPa) value and the fracture mode in each of GFPP/GFPP adhesion and ED/ED adhesion are shown together in Table 1 below.

For the GFPP/GFPP adhesion, the adhesion strength may be evaluated to be: “favorable” in a case of being no less than 8 MPa; “somewhat favorable” in a case of being no less than 5 Mpa and less than 8 Mpa; and “unfavorable” in a case of being less than 5 MPa.

For the ED/ED adhesion, the adhesion strength may be evaluated to be: “favorable” in a case of being no less than 14 MPa; “somewhat favorable” in a case of being no less than 12 Mpa and less than 14 Mpa; and “unfavorable” in a case of being less than 12 MPa.

Flexibility of Adhesion Layer

Each of the two-component adhesives prepared as described above was used to produce a test piece for flexibility measurement in accordance with the following method, and the maximum point stress, the deformation at break and the modulus of elasticity were measured on this test piece for flexibility measurement. The results of the evaluations are shown together in Table 1 below.

Production of Test Piece for Flexibility Measurement

In a similar manner to the case of the above adhesion strength test, the composition (I) and the composition (II) were mixed by a bag-mixing procedure, and an adhesive obtained by mixing was applied on one mold-releasing PET film. Another mold-releasing PET film was overlaid thereon with a spacer having a thickness of 2 mm sandwiched therebetween, and the entirety was pressed until a film thickness became uniform, whereby molding to give a sheet form was completed. After the molded sheet was left to stand at room temperature for 3 days until the adhesive was completely cured, the mold-releasing PET was stripped off and a thus obtained adhesive sheet was cut into a No. 2 dumbbell shape (JIS-K6251) with a dumbbell cutter to produce a test piece for flexibility measurement.

Measurement of Flexibility of Adhesion Layer

In regard to the flexibility of the adhesion layer, the maximum point stress, the deformation at break, and the modulus of elasticity were measured by using the test piece for flexibility measurement in accordance with the following method. The flexibility of the adhesion layer may be evaluated to be superior in a case in which the maximum point stress, the deformation at break, and the modulus of elasticity were all evaluated to be “favorable”.

Using a tensile tester (“Autograph AG5000B” available from Shimadzu Corporation), the dumbbell-shaped test piece for flexibility measurement obtained was subjected to a tensile test until the resin was broken. Conditions of the measurement involved a temperature of 23° C., a distance between chucks of 30 mm, and a test speed of 100 mm/min. A value obtained by dividing a maximum load attained until breaking by a cross sectional area of a center of the dumbbell-shape test piece was determined as the maximum point stress (MPa). A value obtained from a displacement magnitude at a break point by dividing by an initial distance between chucks of 30 mm and then multiplying by 100 was determined as the deformation at break (%). A slope of a stress immediately after start of applying tension was determined as the modulus of elasticity (MPa).

The maximum point stress of the adhesion layer may be evaluated to be: “favorable” in a case of being no less than 5 MPa; and “unfavorable” in a case of being less than 5 MPa.

The deformation at break of the adhesion layer may be evaluated to be: “favorable” in a case of being no less than 20%; and “unfavorable” in a case of being less than 20%.

The modulus of elasticity of the adhesion layer may be evaluated to be: “favorable” in a case of being no less than 50 MPa; and “unfavorable” in a case of being less than 50 MPa”.

TABLE 1

| | | | Exam- | Exam- | Exam- | Exam- | Exam- | Exam- | Exam- |
|---|---|---|---|---|---|---|---|---|---|
| Amount of blending (parts by mass) | | | ple 1 | ple 2 | ple3 | ple 4 | ple 5 | ple 6 | ple 7 |
| Two-component adhesive | | | E-1 | E-2 | E-3 | E-4 | E-5 | E-6 | E-7 |
| (I) | Type | | I-1 | I-2 | I-3 | I-4 | I-5 | I-6 | I-7 |
| Composition | (A) Complex | TEB-DAP | 2.6 | 3.1 | 3.9 | 5.3 | 8.0 | 2.7 | 5.9 |
| | (B) Compound | EXCENOL 823 | 38.6 | 38.4 | 38.0 | 37.5 | 36.4 | 38.5 | 37.3 |
| | | WANOL R2303 | 17.8 | 17.7 | 17.6 | 17.3 | 16.8 | 17.8 | 17.2 |
| | | PP1000 | 38.6 | 38.4 | 38.0 | 37.5 | 36.4 | 38.5 | 37.3 |
| | (X) | TEDA | 0.5 | 0.5 | 0.5 | 0.5 | 0.5 | 0.5 | 0.5 |
| | Urethanization | | | | | | | | |
| | catalyst | | | | | | | | |
| | Inorganic | R202 | 2.0 | 2.0 | 2.0 | 1.9 | 1.9 | 2.0 | 1.9 |
| | filler | | | | | | | | |
| | Total | | 100.0 | 100.0 | 100.0 | 100.0 | 100.0 | 100.0 | 100.0 |
| | Mixing ratio | | 1.0 | 1.0 | 1.0 | 1.0 | 1.0 | 1.0 | 1.0 |
| (II) | Type | | II-1 | II-2 | II-3 | II-4 | II-5 | II-6 | II-7 |
| Composition | (C) Compound | PM-200 | 16.3 | 12.4 | 9.2 | 6.5 | 4.3 | 9.0 | 9.5 |
| | | CDMDI | 16.3 | 12.4 | 9.2 | 6.5 | 4.3 | 9.0 | 9.5 |
| | | DURANATE | — | — | — | — | — | — | — |
| | | TPA-100 | | | | | | | |
| | | TAKENATE 500 | — | — | — | — | — | — | — |
| | (D) Compound | THFMA | 62.3 | 70.1 | 76.6 | 81.9 | 86.4 | 77.0 | 75.9 |
| | (E) Dehydrating | Zeolite 3A | 3.0 | 3.0 | 3.0 | 3.0 | 3.0 | 3.0 | 3.0 |
| | agent | | | | | | | | |
| | (Y) | BHT | 0.1 | 0.1 | 0.1 | 0.1 | 0.1 | 0.1 | 0.1 |
| | Polymerization | TDP | — | — | — | — | — | — | — |
| | inhibitor | | | | | | | | |
| | Inorganic | NS600 | — | — | — | — | — | — | — |
| | tiller | R202 | 2.0 | 2.0 | 2.0 | 2.0 | 2.0 | 2.0 | 2.0 |
| | NCO- | MOI | — | — | — | — | — | — | — |
| | containing | | | | | | | | |
| | methacrylate | | | | | | | | |
| | Total | | 100.0 | 100.0 | 100.0 | 100.0 | 100.0 | 100.0 | 100.0 |
| | Mixing ratio | | 1.6 | 2.1 | 2.9 | 4.2 | 6.9 | 2.8 | 2.9 |
| Amount of | (A) Complex | | 1.0 | 1.0 | 1.0 | 1.0 | 1.0 | 0.7 | 1.5 |
| blending with | (D) Compound | | 37.9 | 47.4 | 56.8 | 66.1 | 75.5 | 56.9 | 56.5 |
| respect to | Total of (B) compound | | 57.0 | 47.4 | 37.8 | 28.3 | 18.8 | 38.0 | 37.6 |
| total of | and (C) compound | | | | | | | | |
| Compositions | | | | | | | | | |
| (I) and (II) | | | | | | | | | |
| (% by mass) | | | | | | | | | |
| Mass ratio in | (D) Compound/((B) | | 0.40 | 0.50 | 0.60 | 0.70 | 0.80 | 0.60 | 0.60 |
| compositions | compound + (C) compound) | | | | | | | | |
| (I) and (II) | | | | | | | | | |
| | (A) Complex/(D) compound | | 0.027 | 0.021 | 0.018 | 0.015 | 0.013 | 0.012 | 0.027 |
| Evaluations | Adhesion | GFPP/GFPP | 5.2 AF | 8.1 SF | 10.6 SF | 10.1 SF | 10.6 SF | 8.2 SF | 9.1 SF |
| | strength | ED/ED | 12.8 CF | 25.9 CF | 24.3 CF | 22.3 CF | 26.1 CF | 20.1 CF | 18.9 CF |
| | (MPa) | | | | | | | | |
| | Flexibility | maximum | 10.5 | 16.5 | 18.2 | 17.8 | 20.1 | 18.7 | 18.1 |
| | of adhesion | point stress | | | | | | | |
| | layer | (MPa) | | | | | | | |
| | | deformation | 224 | 238 | 244 | 110 | 56 | 234 | 214 |
| | | at break (%) | | | | | | | |
| | | modulus of | 112 | 220 | 236 | 471 | 728 | 215 | 226 |
| | | elasticity | | | | | | | |
| | | (MPa) | | | | | | | |

| | | | | | | | Compar- | Compar- |
|---|---|---|---|---|---|---|---|---|
| | | | | | | | ative | ative |
| | | | Exam- | Exam- | Exam- | Exam- | Exam- | Exam- |
| Amount of blending (parts by mass) | | | ple 8 | ple 9 | ple 10 | ple 11 | ple 1 | ple 2 |
| Two-component adhesive | | | E-8 | E-9 | E-10 | E-11 | CE-1 | CE-2 |
| (I) | Type | | I-8 | I-9 | I-10 | I-11 | CI-1 | CI-2 |
| Composition | (A) Complex | TEB-DAP | 7.9 | 4.4 | 3.4 | 3.9 | 3.9 | 100.0 |
| | (B) Compound | EXCENOL 823 | 36.4 | 37.8 | 38.2 | 38.0 | 38.0 | — |
| | | WANOL R2303 | 16.8 | 17.5 | 17.6 | 17.6 | 17.6 | — |
| | | PP1000 | 36.4 | 37.8 | 38.2 | 38.0 | 38.0 | — |
| | (X) | TEDA | 0.5 | 0.5 | 0.5 | 0.5 | 0.5 | — |
| | Urethanization | | | | | | | |
| | catalyst | | | | | | | |
| | Inorganic | R202 | 1.9 | 1.9 | 2.0 | 2.0 | 2.0 | — |
| | filler | | | | | | | |
| | Total | | 100.0 | 100.0 | 100.0 | 100.0 | 100.0 | 100.0 |
| | Mixing ratio | | 1.0 | 1.0 | 1.0 | 1.0 | 1.0 | 1.0 |
| (II) | Type | | II-8 | II-9 | II-10 | II-11 | CII-1 | CII-2 |
| Composition | (C) Compound | PM-200 | 9.9 | — | — | 9.2 | 9.2 | — |
| | | CDMDI | 9.9 | — | — | 9.2 | 9.2 | — |
| | | DURANATE | — | 21.6 | — | — | — | — |
| | | TPA-100 | | | | | | |
| | | TAKENATE 500 | — | — | 14.5 | — | — | — |
| | (D) Compound | THFMA | 75.2 | 73.3 | 80.4 | 76.6 | 76.6 | 89.4 |
| | (E) Dehydrating | Zeolite 3A | 3.0 | 3.0 | 3.0 | 3.0 | — | 3.0 |
| | agent | | | | | | | |
| | (Y) | BHT | 0.1 | 0.1 | 0.1 | — | 0.1 | — |
| | Polymerization | TDP | — | — | — | 0.1 | — | — |
| | inhibitor | | | | | | | |
| | Inorganic | NS600 | — | — | — | — | 3.0 | — |
| | tiller | R202 | 2.0 | 2.0 | 2.0 | 2.0 | 2.0 | — |
| | NCO- | MOI | — | — | — | — | — | 7.6 |
| | containing | | | | | | | |
| | methacrylate | | | | | | | |
| | Total | | 100.0 | 100.0 | 100.0 | 100.0 | 100.0 | 100.0 |
| | Mixing ratio | | 3.0 | 3.4 | 2.4 | 2.9 | 2.9 | 40 |
| Amount of | (A) Complex | | 2.0 | 1.0 | 1.0 | 1.0 | 1.0 | 2.4 |
| blending with | (D) Compound | | 56.2 | 56.7 | 56.8 | 56.8 | 56.8 | 87.2 |
| respect to | Total of (B) compound | | 37.4 | 37.8 | 37.9 | 37.8 | 37.8 | — |
| total of | and (C) compound | | | | | | | |
| Compositions | | | | | | | | |
| (I) and (II) | | | | | | | | |
| (% by mass) | | | | | | | | |
| Mass ratio in | (D) Compound/((B) | | 0.60 | 0.60 | 0.60 | 0.60 | 0.60 | — |
| compositions | compound + (C) compound) | | | | | | | |
| (I) and (II) | | | | | | | | |
| | (A) Complex/(D) compound | | 0.036 | 0.018 | 0.018 | 0.018 | 0.018 | 0.028 |
| Evaluations | Adhesion | GFPP/GFPP | 10.1 SF | 10.2 SF | 11.5 SF | 9.9 SF | 11.0 SF | 10.1 SF |
| | strength | ED/ED | 18.2 CF | 14.2 CF | 12.7 CF | 20.6 CF | 22.3 CF | 21.4 CF |
| | (MPa) | | | | | | | |
| | Flexibility | maximum | 17.6 | 13.8 | 11.6 | 16.8 | 19.5 | 19.6 |
| | of adhesion | point stress | | | | | | |
| | layer | (MPa) | | | | | | |
| | | deformation | 205 | 384 | 305 | 239 | 260 | 5 |
| | | at break (%) | | | | | | |
| | | modulus of | 259 | 201 | 165 | 269 | 249 | 458 |
| | | elasticity | | | | | | |
| | | (MPa) | | | | | | |

Storage Stability

The two-component adhesive (E-3) of Example 3 and the two-component adhesive (CE-1) of Comparative Example 1, each prepared as described above, were evaluated on the storage stability in accordance with the following method. The results of the evaluations are shown in Table 2 below.

Evaluation of Storage Stability

The composition (I) and the composition (II) of the two-component adhesive were each placed in a can, and stored at a storage temperature of 40° C. for each of the following number of days of the storage: 0 days (composition immediately after preparation), 30 days, 60 days, and 90 days. In a similar manner to the above “Production of test piece for flexibility measurement”, the composition (I) and the composition (II) each stored as described above were used to produce a test piece for adhesion strength measurement in a case in which the adherend was a glass fiber-reinforced polypropylene/glass fiber-reinforced polypropylene (GFPP/GFPP), and the adhesion strength was measured similarly to the above “Shear test” to evaluate the fracture mode.

TABLE 2
Adhesion strength (GFPP/GFPP) (MPa)

| | | | Example 3 | Comparative Example 1 |
|---|---|---|---|---|
| Two-component | | | E-3 | CE-1 |
| adhesive | | | | |
| | Number of | 0 | 10.6 SF | 11.0 SF |
| | days stored | 30 | 9.5 SF | 10.4 SF (composition (II), |
| | at 40° C. | | | viscosity increased) |
| | (days) | 60 | 10.0 SF | 3.1 AF (composition (II), |
| | | | | viscosity increased) |
| | | 90 | 9.1 SF | 0 AF (composition (II), |
| | | | | viscosity increased) |

From the results shown in Tables 1 and 2, the two-component adhesives of the Examples each including the composition (I) containing the complex (A) and the compound (B), as well as the composition (II) containing the compound (C), the compound (D) and the dehydrating agent (E) were revealed to be capable of forming an adhesion layer superior in flexibility while maintaining the adhesion strength, and to be superior in storage stability.

### INDUSTRIAL APPLICABILITY

The two-component adhesive of the embodiment of the present invention is capable of forming an adhesion layer superior in flexibility while maintaining the adhesion strength, and is superior in storage stability. Therefore, the two-component adhesive can be suitably used for adhesion of a variety of materials including poorly adhesive materials such as outer panels for automobiles.

1. A two-component adhesive, comprising:
a first composition, and
a second composition,
wherein the first composition comprises: a complex derived from a first compound comprising a first group capable of undergoing an addition reaction to an organoborane and an isocyanate group; and a second compound comprising a plurality of hydroxy groups, and
the second composition comprises: a third compound comprising a plurality of isocyanate groups; a fourth compound comprising a polymerizable group; and a dehydrating agent.

2. The two-component adhesive according to claim 1, wherein provided that a mass of the fourth compound in the second composition is X, and that a total mass of the second compound in the first composition and the third compound in the second composition is Y, a value X/(X+Y) is no less than 0.4 and no greater than 0.85.

3. The two-component adhesive according to claim 1, wherein the second compound is at least one selected from the group consisting of a polyether polyol, a polyester polyol, and a polybutadiene polyol.

4. The two-component adhesive according to claim 1, wherein the third compound is at least one selected from the group consisting of an aromatic or aliphatic polyisocyanate, and a prepolymer comprising at an end thereof a plurality of isocyanate groups that is a reaction product of the polyisocyanate and a polyol.

5. The two-component adhesive according to claim 1, wherein the polymerizable group of the fourth compound is a (meth)acryloyl group.

6. The two-component adhesive according to claim 1, wherein the dehydrating agent is zeolite.

7. The two-component adhesive according to claim 1, wherein the first composition comprises substantially no compound comprising a polymerizable group.

8. The two-component adhesive according to claim 1, wherein the first group of the first compound is an amino group.

9. The two-component adhesive according to claim 1, wherein the first composition further comprises a urethanization catalyst.

10. The two-component adhesive according to claim 1, wherein the second composition further comprises a polymerization inhibitor.

11. The two-component adhesive according to claim 10, wherein the polymerization inhibitor is at least one selected from the group consisting of a phenol-based polymerization inhibitor and a phenothiazine-based polymerization inhibitor.
